(19) United States
(12) Patent Application Publication
(10) Pub. No.: US 2023/0089331 A1
(43) Pub. Date: Mar. 23, 2023

(54) Pattern-Based Identification of Sensitive Data in a Storage System

(71) Applicant: Dell Products L.P., Round Rock, TX (US)

(72) Inventors: Tomer Shachar, Omer (IL); Maxim Balin, Gan Yavne (IL); Yevgeni Gehtman, Modi'in (IL)

(21) Appl. No.: 17/483,213

(22) Filed: Sep. 23, 2021

(51) Int. Cl. G06F 21/62; G06F 16/245

(52) U.S. Cl. CPC G06F 21/6245; G06F 16/245

(57) ABSTRACT

Techniques are provided for pattern-based identification of sensitive data in a storage system. One method comprises obtaining, in a storage system, one or more patterns indicating sensitive data; evaluating whether one or more files of the storage system comprise sensitive data by searching for the one or more patterns in the one or more files; and classifying, in the storage system, at least one of the one or more files as comprising sensitive data based on a result of the evaluating. In response to a file type of a file being written supporting text, an identifier of the file being written can be stored in a list of files to be evaluated, and the one or more files subject to the evaluating can be identified using the list. The evaluating may be performed in response to a load of the storage system satisfying one or more sensitive data evaluation criteria.

### FIELD

The field relates generally to information processing techniques and more particularly, to the protection of data in such information processing systems.

### BACKGROUND

Data protection techniques are often employed to secure data in a storage system, typically using encryption and other access control functions. Many organizations, however, desire additional protection for the storage of sensitive information, such as personally identifiable information (PII). PII comprises information that allows an identity of an individual to be directly or indirectly inferred. In some regions, regulations may require additional protection for the storage of such sensitive information.

A need exists for improved techniques for identifying sensitive data in a storage system.

### SUMMARY

In one embodiment, a method comprises obtaining, in a storage system, one or more patterns indicating sensitive data, the storage system comprising at least one processing device, the at least one processing device comprising a processor coupled to a memory; evaluating, in the storage system, whether one or more files of the storage system comprise sensitive data by searching for the one or more patterns in the one or more files; and classifying, in the storage system, at least one of the one or more files as comprising sensitive data based at least in part on a result of the evaluating.

In some embodiments, in response to a file type of a file being written supporting text, an identifier of the file being written can be stored in a list of files to be evaluated, and the one or more files subject to the evaluating can be identified using the list. The evaluating may be performed in response to a load of the storage system satisfying one or more sensitive data evaluation criteria.

In one or more embodiments, the sensitive data comprises personally identifiable information, and the one or more patterns comprise at least one pattern for each of a plurality of types of personally identifiable information.

Other illustrative embodiments include, without limitation, apparatus, systems, methods and computer program products comprising processor-readable storage media.

### BRIEF DESCRIPTION OF THE DRAWINGS

FIG. 1 illustrates a computer network configured for pattern-based identification of sensitive data in a storage system in accordance with an illustrative embodiment;

FIG. 2 illustrates the pattern-based PII identification module of FIG. 1 in further detail according to one or more embodiments;

FIG. 3 is a flow diagram illustrating an exemplary implementation of a process for identifying files that should be evaluated for the presence of PII, according to at least one embodiment;

FIG. 4 is a flow diagram illustrating an exemplary implementation of a pattern-based process for identifying PII in a storage system, according to various embodiments;

FIG. 5 is a flow diagram illustrating an exemplary implementation of a pattern-based process for identifying sensitive data in a storage system, according to various embodiments;

FIG. 6 illustrates an exemplary processing platform that may be used to implement at least a portion of one or more embodiments of the disclosure comprising a cloud infrastructure; and

FIG. 7 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for pattern-based identification of sensitive data in a storage system.

In one or more embodiments, techniques are provided for identifying sensitive data in a storage system. The protection of sensitive data, such as data comprising PII, by an organization depends largely on an ability to know where such sensitive data is stored. The ability to identify sensitive data is even more challenging, for example, when the sensitive data is stored in a storage system that stores a large amount of data (e.g., on the order of terabytes).

The disclosed pattern-based techniques for identifying sensitive data in a storage system, in at least some embodiments, identify sensitive data using an independent layer of the storage system. In this manner, the disclosed techniques for pattern-based identification of sensitive data can be performed in some embodiments without significantly impairing the performance of the storage system.

Among other benefits, the disclosed techniques allow an organization to know where sensitive data is stored within a storage system and to take appropriate action to protect the identified sensitive data, if needed. For example, an organization may perform one or more automated actions for files comprising sensitive data, such as: (i) enforcing one or more regulatory and/or industry requirements, (ii) sanitizing at least one file of the identified sensitive data, (iii) mitigating a leakage of the identified sensitive data, and/or (iv) restricting access to the files comprising the sensitive data.

PII may include a number of types of PII, such as a name of a person, a personal identification number of a person (such as a Social Security number or another identifier of a person, such as a passport number or a driver's license number), biometric information, a financial account number and/or address information (including telephone numbers, street addresses and email addresses, or portions thereof). As noted above, the disclosed pattern-based techniques for identifying sensitive data in a storage system employ one or more patterns to identify the sensitive data.

In some embodiments, at least one pattern can be employed for each type of PII. A Social Security number in the United States, for example, typically comprises nine digits in three fields separated by hyphens (e.g., AAA-GG-SSSS). The first field is considered an area number, the second field is considered a group number, and the third field is considered a serial number. A pattern expression can be defined that focuses on the specific pattern of a Social Security number (and similarly for other types of PII). There are existing tools available to identify certain types of PII.

The patterns may comprise, for example, a sequence of characters (e.g., a text string), a mask (such as character types for each character), a regular expression, and one or more predefined characters (such as an “@” symbol for an email address), and portions and/or combinations thereof, to be identified in a file, for example, using pattern matching techniques that detect the presence of the constituents of a predefined pattern.

While one or more embodiments of the disclosure are illustrated in the context of identifying PII in a stored file, the disclosed pattern-based techniques can be used to identify any form of sensitive data, as would be apparent to a person of ordinary skill in the art.

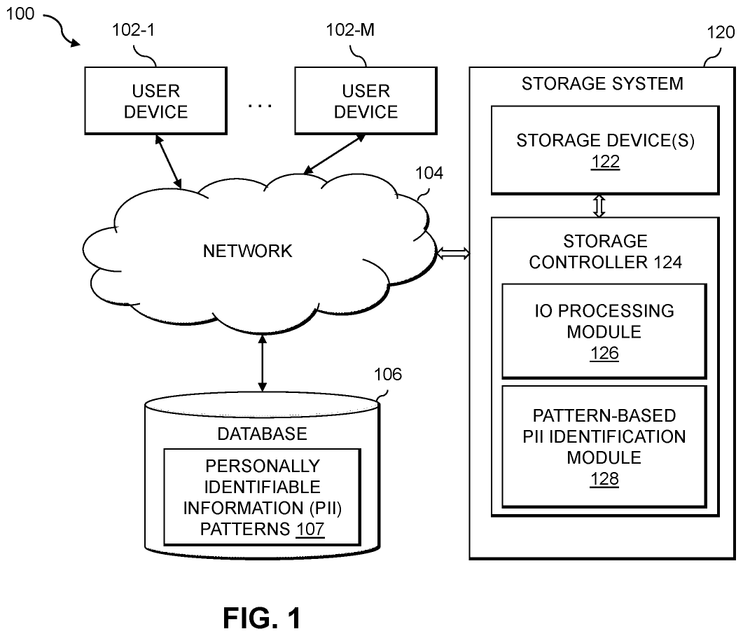

FIG. 1 shows a computer network (also referred to herein as an information processing system) 100 configured in accordance with an illustrative embodiment. The computer network 100 comprises a plurality of user devices 102-1, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is a database 106, and a storage system 120.

The user devices 102 may comprise, for example, host devices and/or other devices such as mobile telephones, laptop computers, tablet computers, desktop computers or other types of computing devices. Such devices are examples of what are more generally referred to herein as “processing devices.” Some of these processing devices are also generally referred to herein as “computers.” When the user devices 102 are implemented as host devices, the host devices may illustratively comprise servers or other types of computers of an enterprise computer system, cloud-based computer system or other arrangement of multiple compute nodes associated with respective users.

For example, the host devices in some embodiments illustratively provide compute services such as execution of one or more applications on behalf of each of one or more users associated with respective ones of the host devices. Such applications illustratively generate input/output (IO) operations that are processed by the storage system 120. The term “input/output” as used herein refers to at least one of input and output. For example, IO operations may comprise write requests and/or read requests directed to logical addresses of a particular logical storage volume of the storage system 120. These and other types of IO operations are also generally referred to herein as IO requests.

The user devices 102 in some embodiments comprise respective processing devices associated with a particular company, organization or other enterprise or group of users. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities. Compute and/or storage services may be provided for users under a Platform-as-a-Service (PaaS) model, an Infrastructure-as-a-Service (IaaS) model and/or a Function-as-a-Service (FaaS) model, although it is to be appreciated that numerous other cloud infrastructure arrangements could be used. Also, illustrative embodiments can be implemented outside of the cloud infrastructure context, as in the case of a stand-alone computing and storage system implemented within a given enterprise.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The network 104 in some embodiments therefore comprises combinations of multiple different types of networks, each comprising processing devices configured to communicate using internet protocol (IP) or other related communication protocols.

The storage system 120 illustratively comprises processing devices of one or more processing platforms. For example, the storage system 120 can comprise one or more processing devices each having a processor and a memory, possibly implementing virtual machines and/or containers, although numerous other configurations are possible.

The storage system 120 can additionally or alternatively be part of cloud infrastructure such as an Amazon Web Services (AWS) system. Other examples of cloud-based systems that can be used to provide at least portions of the storage system 120 include Google Cloud Platform (GCP) and Microsoft Azure.

The user devices 102 and the storage system 120 may be implemented on a common processing platform, or on separate processing platforms. The user devices 102 (for example, when implemented as host devices) are illustratively configured to write data to and read data from the storage system 120 in accordance with applications executing on those host devices for system users.

The storage system 120 comprises a plurality of storage devices 122 and an associated storage controller 124. The storage devices 122 store data of a plurality of storage volumes, such as respective logical units (LUNs) or other types of logical storage volumes. The term “storage volume” as used herein is intended to be broadly construed, and should not be viewed as being limited to any particular format or configuration.

The storage devices 122 of the storage system 120 illustratively comprise solid state drives (SSDs). Such SSDs are implemented using non-volatile memory (NVM) devices such as flash memory. Other types of NVM devices that can be used to implement at least a portion of the storage devices 122 include non-volatile RAM (NVRAM), phase-change RAM (PC-RAM), magnetic RAM (MRAM), resistive RAM, spin torque transfer magneto-resistive RAM (STT-MRAM), and Intel Optane™ devices based on 3D XPoint™ memory. These and various combinations of multiple different types of NVM devices may also be used. For example, hard disk drives (HDDs) can be used in combination with or in place of SSDs or other types of NVM devices in the storage system 120.

It is therefore to be appreciated numerous different types of storage devices 122 can be used in storage system 120 in other embodiments. For example, a given storage system as the term is broadly used herein can include a combination of different types of storage devices, as in the case of a multi-tier storage system comprising a flash-based fast tier and a disk-based capacity tier. In such an embodiment, each of the fast tier and the capacity tier of the multi-tier storage system comprises a plurality of storage devices with different types of storage devices being used in different ones of the storage tiers. For example, the fast tier may comprise flash drives while the capacity tier comprises HDDs. The particular storage devices used in a given storage tier may be varied in other embodiments, and multiple distinct storage device types may be used within a single storage tier. The term “storage device” as used herein is intended to be broadly construed, so as to encompass, for example, SSDs, HDDs, flash drives, hybrid drives or other types of storage devices.

The term “storage system” as used herein is therefore intended to be broadly construed, and should not be viewed as being limited to particular storage system types, such as, for example, CAS systems, distributed storage systems, or storage systems based on flash memory or other types of NVM storage devices. A given storage system as the term is broadly used herein can comprise, for example, any type of system comprising multiple storage devices, such as network-attached storage (NAS), storage area networks (SANs), direct-attached storage (DAS) and distributed DAS, as well as combinations of these and other storage types, including software-defined storage.

The user devices 102 are configured to interact over the network 104 with the storage system 120. Such interaction illustratively includes generating IO operations, such as write and read requests, and sending such requests over the network 104 for processing by the storage system 120. In some embodiments, one or more of the user devices 102 comprise a multi-path input/output (MPIO) driver configured to control delivery of IO operations from the respective user device 102 to the storage system 120 over selected ones of a plurality of paths through the network 104. The paths are illustratively associated with respective initiator-target pairs, with each of a plurality of initiators of the initiator-target pairs comprising a corresponding host bus adaptor (HBA) of the host device, and each of a plurality of targets of the initiator-target pairs comprising a corresponding port of the storage system 120.

The MPIO driver may comprise, for example, an otherwise conventional MPIO driver, such as a PowerPath® driver from Dell Technologies. Other types of MPIO drivers from other driver vendors may be used.

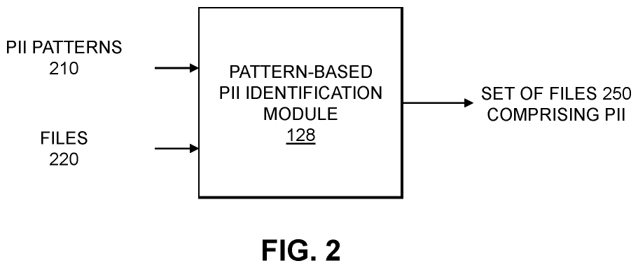

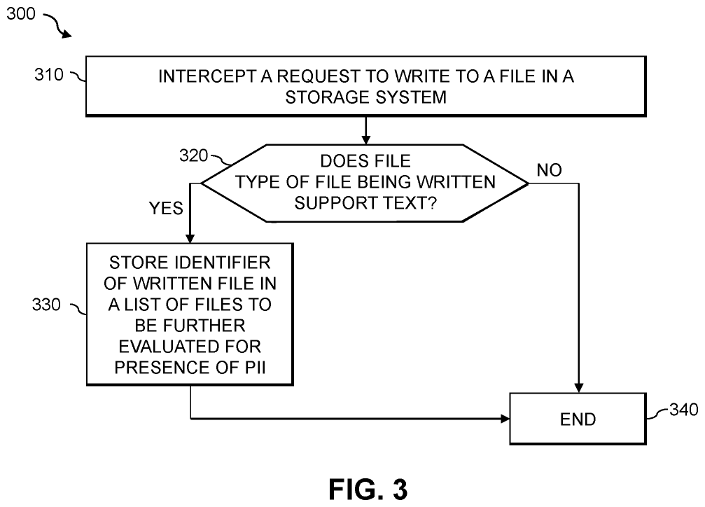

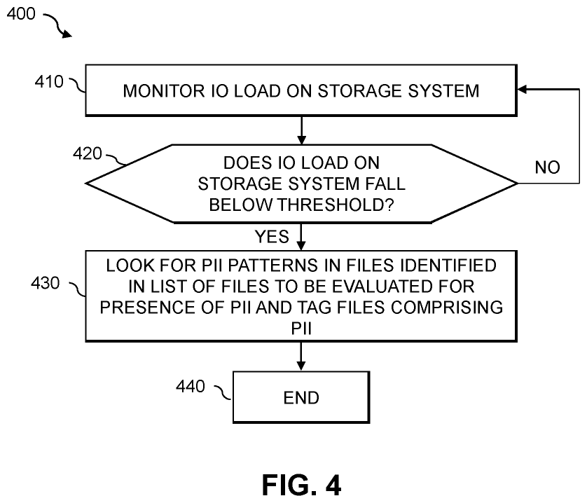

As shown in FIG. 1, the exemplary storage controller 124 comprises an IO processing module 126 and a pattern-based PII identification module 128, as discussed further below in conjunction with FIGS. 2 through 4. In one or more embodiments, the IO processing module 126 evaluates IO operations that are processed by the storage system 120 to identify files requiring further evaluation for the presence of PII, as discussed further below in conjunction with FIG. 3. The pattern-based PII identification module 128 monitors an IO load of the storage system 120 and looks for PII patterns in previously identified files at times of lower IO load (or storage system utilization or activity), as discussed further below in conjunction with FIG. 4.

It is to be appreciated that this particular arrangement of modules 126, 128 illustrated in the storage controller 124 of the FIG. 1 embodiment is presented by way of example only, and alternative arrangements can be used in other embodiments. For example, the functionality associated with modules 126, 128 in other embodiments can be combined into a single module, or separated across a larger number of modules. As another example, multiple distinct processors and/or memory elements can be used to implement different ones of modules 126, 128 or portions thereof. At least portions of modules 126, 128 may be implemented at least in part in the form of software that is stored in memory and executed by a processor.

The storage controller 124 and the storage system 120 may further include one or more additional modules and other components typically found in conventional implementations of storage controllers and storage systems, although such additional modules and other components are omitted from the figure for clarity and simplicity of illustration.

The storage system 120 in some embodiments is implemented as a distributed storage system, also referred to herein as a clustered storage system, comprising a plurality of storage nodes. Each of at least a subset of the storage nodes illustratively comprises a set of processing modules configured to communicate with corresponding sets of processing modules on other ones of the storage nodes. The sets of processing modules of the storage nodes of the storage system 120 in such an embodiment collectively comprise at least a portion of the storage controller 124 of the storage system 120. For example, in some embodiments the sets of processing modules of the storage nodes collectively comprise a distributed storage controller of the distributed storage system 120. A “distributed storage system” as that term is broadly used herein is intended to encompass any storage system that, like the storage system 120, is distributed across multiple storage nodes.

Each storage node of a distributed implementation of storage system 120 illustratively comprises a CPU or other type of processor, a memory, a network interface card (NIC) or other type of network interface, and a subset of the storage devices 122, possibly arranged as part of a disk array enclosure (DAE) of the storage node. These and other references to “disks” herein are intended to refer generally to storage devices, including SSDs, and should therefore not be viewed as limited to spinning magnetic media.

The storage system 120 in the FIG. 1 embodiment is assumed to be implemented using at least one processing platform, with each such processing platform comprising one or more processing devices, and each such processing device comprising a processor coupled to a memory. Such processing devices can illustratively include particular arrangements of compute, storage and network resources. As indicated previously, the user devices 102 (for example, when implemented as host devices) may be implemented in whole or in part on the same processing platform as the storage system 120 or on a separate processing platform.

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for the user devices 102 and the storage system 120 to reside in different data centers. Numerous other distributed implementations of the host devices and the storage system 120 are possible.

As noted above, the storage controller 124 can have an associated database 106 configured to store one or more PII patterns 107. Although the PII patterns 107 are shown in FIG. 1 as a separate component within database 106, in other embodiments, an additional or alternative instance of the PII patterns 107, or portions thereof, may be incorporated into the storage controller 124 or other portions of storage system 120. The PII patterns 107 may be configured to store, in at least some embodiments, a number of patterns to identify one or more types of PII.

The database 106 in the present embodiment is implemented using one or more storage systems 120. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with one or more of the user devices 102 can be one or more input/output devices (not shown), which illustratively comprise keyboards, displays or other types of input/output devices in any combination. Such input/output devices can be used, for example, to support one or more user interfaces to the user devices 102, as well as to support communication between the user devices 102 and other related systems and devices not explicitly shown.

The user devices 102 in the FIG. 1 embodiment are assumed to be implemented using at least one processing device. Each such processing device generally comprises at least one processor and an associated memory, and implements one or more functional modules for controlling certain features of the user devices 102. More particularly, the user devices 102 in this embodiment can comprise a processor coupled to a memory and a network interface. The network interface allows the user devices 102 to communicate over the network 104 with each other (as well as one or more other networked devices), and illustratively comprises one or more conventional transceivers.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

It is to be understood that the particular set of elements shown in FIG. 1 for pattern-based identification of sensitive data is presented by way of illustrative example only, and in other embodiments additional or alternative elements may be used. Thus, another embodiment includes additional or alternative systems, devices and other network entities, as well as different arrangements of modules and other components.

FIG. 2 illustrates the pattern-based PII identification module 128 of FIG. 1 in further detail according to one or more embodiments. As noted above, the pattern-based PII identification module 128 monitors an IO load of the storage system 120 and looks for PII patterns in previously identified files at times of lower IO load (or storage system utilization). In the example of FIG. 2, the pattern-based PII identification module 128 obtains one or more PII patterns 210 (for example, from the PII patterns 107 in the database 106) and one or more files 220. The pattern-based PII identification module 128 looks for the one or more PII patterns 210 in the one or more files 220 and generates a set of files 250 comprising PII, as discussed further below.

In some embodiments, the disclosed techniques for pattern-based identification of sensitive data in a storage system are performed in two phases. In a first phase, the IO processing module 126 monitors the IO requests and for any write operations (e.g., save or edit a file), the file type of the written file is evaluated to determine if the file type supports text. If the file type supports text, the file is flagged as potentially comprising PII (indicating that the file needs to be further examined).

In a second phase, the pattern-based PII identification module 128 monitors an IO load (or utilization) of the storage system 120 and when the storage system 120 is less busy (e.g., when a utilization metric falls below a threshold value), each of the files identified in the first phase are evaluated for the presence of PII. In this manner, in some embodiments, the disclosed sensitive data identification techniques are performed when the storage system 120 has additional resources to perform the identification without significantly impairing the performance of the storage system 120. In further variations, the disclosed sensitive data identification techniques can be performed according to a schedule (e.g., when the storage system 120 is expected to be less busy). If an evaluated file comprises PII, the pattern-based PII identification module 128 tags the evaluated file as comprising PII.

FIG. 3 is a flow diagram illustrating an exemplary implementation of a process 300 for identifying files that should be evaluated for the presence of PII, according to at least one embodiment. As noted above, in a first phase, in some embodiments, the IO processing module 126 monitors the IO requests and evaluates the file type of the written file to determine if the file type supports text (e.g., text files, word processing documents and spreadsheets). If the file type supports text, the file is flagged as potentially comprising PII.

In the example of FIG. 3, the process 300 intercepts requests in step 310 to write to a file (e.g., a portion of a file) in storage system 120. A test is performed in step 320 to determine if the file type of the file being written supports text. If it is determined in step 320 that the file type of the file being written supports text, then an identifier of the written file is stored in step 330 in a list of files to be further evaluated for the presence of PII.

If it is determined in step 320 that the file type of the file being written does not support text, then program control ends in step 340 without adding the file to the list of files to be further evaluated for the presence of PII.

FIG. 4 is a flow diagram illustrating an exemplary implementation of a pattern-based process 400 for identifying PII in a storage system, according to various embodiments. As noted above, in some embodiments, the pattern-based PII identification module 128 monitors an IO load of the storage system 120 and looks for PII patterns in previously identified files at times of lower IO load (or storage system utilization). In the example of FIG. 4, the pattern-based process 400 monitors the IO load on the storage system 120 in step 410.

A test is performed in step 420 to determine if the IO load on the storage system 120 falls below a threshold. The threshold may provide an indication when the storage system 120 is less busy (e.g., when a utilization metric of the storage system 120 falls below the threshold value). In this manner, the disclosed techniques for pattern-based identification of sensitive data in a storage system can trigger the PII scanning without significantly impacting users and/or the performance of the storage system 120.

If it is determined in step 420 that the IO load on the storage system 120 has not fallen below the threshold, then the pattern-based process 400 returns to step 410 to continue monitoring the IO load (or other activity) of the storage system 120.

Once it is determined in step 420 that the IO load on the storage system 120 has fallen below the threshold, then the pattern-based process 400 looks for the PII patterns in step 430 in the files that were identified (in the first phase by the process 300) in the list of files to be evaluated for the presence of PII. The files that comprise PII are tagged as files comprising PII. Program control ends in step 440.

The PII scanning in step 430 may comprise, for example, reading the files in the list from the first phase, and looking for the defined PII patterns in the files. The files can be parsed or otherwise analyzed, for example, in the RAM memory of the storage system 120 to look for the PII patterns. Information suppression techniques may be employed so that the PII of a particular person is not associated with the particular person (e.g., the process 400 will look for the pattern indicators and not any particular PII).

If PII is found in a given file, the file can be tagged in step 430, for example, by placing a PII marker in the metadata and/or file properties of the file.

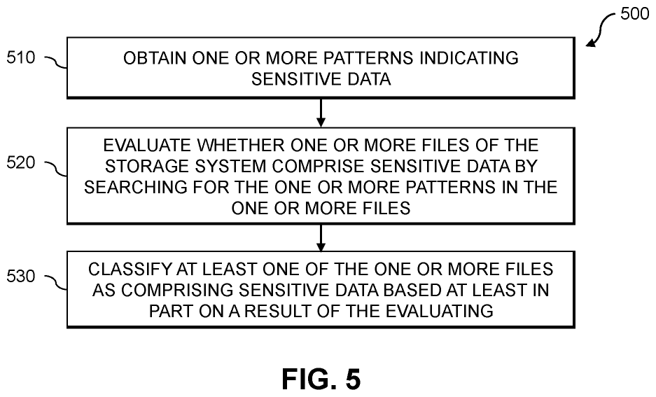

FIG. 5 is a flow diagram illustrating an exemplary implementation of a pattern-based process 500 for identifying sensitive data in a storage system, according to various embodiments. In the example of FIG. 5, the process 500 initially obtains one or more patterns in step 510 indicating sensitive data. In step 520, the process 500 evaluates whether one or more files of the storage system comprise sensitive data by searching for the one or more patterns in the one or more files.

At least one of the one or more files is classified in step 530 as comprising sensitive data based at least in part on a result of the evaluating in the prior step.

In some embodiments, the process 500 also (i) evaluates whether a file type of a file being written supports text, and (ii) stores an identifier of the file being written in a list of files to be evaluated in response to a file type of a file being written supporting text. In this manner, the one or more files evaluated in step 520 can be obtained from the list.

In one or more embodiments, the evaluating is performed in step 520 in response to a load of the storage system satisfying one or more sensitive data evaluation criteria (e.g., when the storage system 120 is less busy, or when a utilization metric of the storage system 120 falls below the threshold value).

The sensitive data may comprise PII in some embodiments, and the one or more patterns may comprise at least one pattern for each type of PII.

In at least one embodiment, one or more automated actions can be initiated in response to at least one of the files being classified as comprising sensitive data. For example, the one or more automated actions may comprise: (i) enforcing one or more regulatory requirements for the at least one file, (ii) enforcing one or more industry requirements for the at least one file, (iii) sanitizing the at least one file of the sensitive data, (iv) mitigating a leakage of the sensitive data in the at least one file, and/or (v) restricting access to the at least one file.

The particular processing operations and other network functionality described in conjunction with the flow diagram of FIG. 5 are presented by way of illustrative example only, and should not be construed as limiting the scope of the disclosure in any way. Alternative embodiments can use other types of processing operations for pattern-based identification of sensitive data in a storage system. For example, the ordering of the process steps may be varied in other embodiments, or certain steps may be performed concurrently with one another rather than serially. In one aspect, the process can skip one or more of the actions. In other aspects, one or more of the actions are performed simultaneously. In some aspects, additional actions can be performed.

One or more embodiments of the disclosure provide improved methods, apparatus and computer program products for pattern-based identification of sensitive data in a storage system. The foregoing applications and associated embodiments should be considered as illustrative only, and numerous other embodiments can be configured using the techniques disclosed herein, in a wide variety of different applications.

It should also be understood that the disclosed pattern-based techniques for identifying sensitive data in a storage system, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for pattern-based identification of sensitive data in a storage system may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services can be offered to cloud infrastructure tenants or other system users as a PaaS, IaaS and/or a Function-as-a-Service FaaS offering, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based sensitive data identification engine, or portions thereof, are illustratively implemented for use by tenants of such a multi-tenant environment.

Cloud infrastructure as disclosed herein can include cloud-based systems such as AWS, GCP and Microsoft Azure. Virtual machines provided in such systems can be used to implement at least portions of a cloud-based sensitive data identification platform in illustrative embodiments. The cloud-based systems can include object stores such as Amazon S3, GCP Cloud Storage, and Microsoft Azure Blob Storage.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

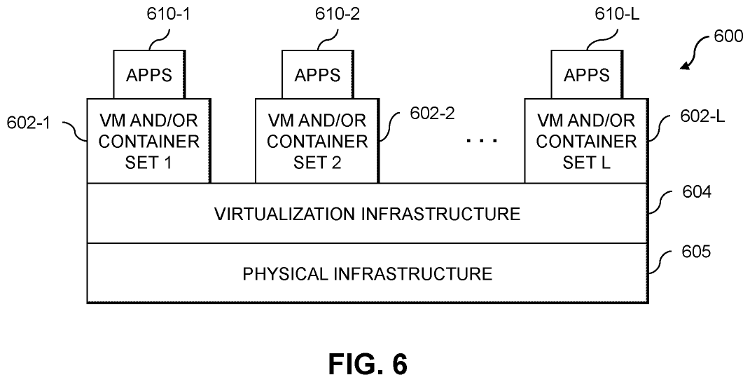

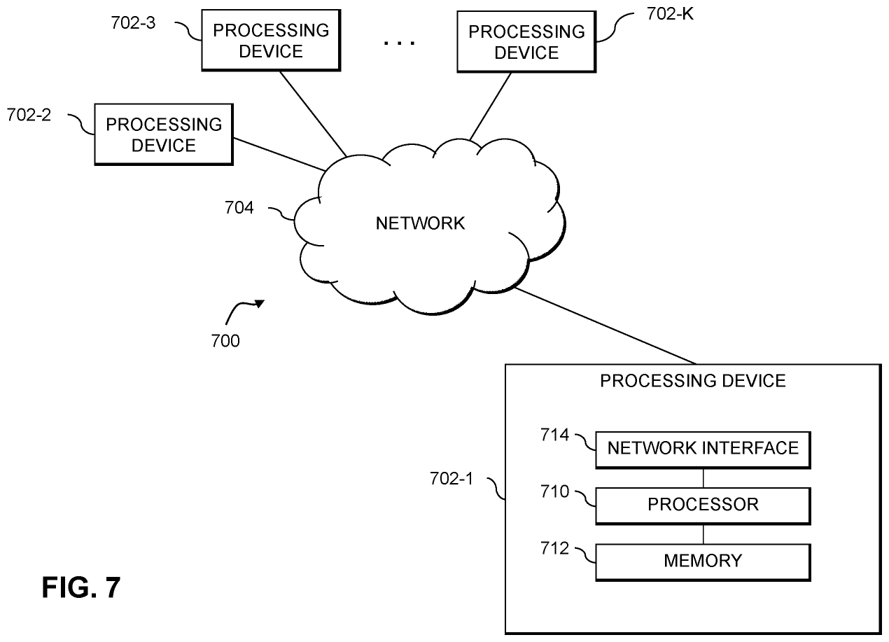

Illustrative embodiments of processing platforms will now be described in greater detail with reference to FIGS. 6 and 7. These platforms may also be used to implement at least portions of other information processing systems in other embodiments.

FIG. 6 shows an example processing platform comprising cloud infrastructure 600. The cloud infrastructure 600 comprises a combination of physical and virtual processing resources that may be utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 may comprise respective VMs, respective sets of one or more containers, or respective sets of one or more containers running in VMs.

In some implementations of the FIG. 6 embodiment, the VMs/container sets 602 comprise respective VMs implemented using virtualization infrastructure 604 that comprises at least one hypervisor. Such implementations can provide pattern-based sensitive data identification functionality of the type described above for one or more processes running on a given one of the VMs. For example, each of the VMs can implement pattern-based sensitive data identification control logic and associated functionality for managing the sensitive data patterns for one or more processes running on that particular VM.

An example of a hypervisor platform that may be used to implement a hypervisor within the virtualization infrastructure 604 is the VMware® vSphere® which may have an associated virtual infrastructure management system such as the VMware® vCenter™. The underlying physical machines may comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system. Such implementations can provide pattern-based sensitive data identification functionality of the type described above for one or more processes running on different ones of the containers. For example, a container host device supporting multiple containers of one or more container sets can implement one or more instances of pattern-based sensitive data identification control logic and associated functionality for managing the sensitive data patterns.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises at least a portion of the given system and includes a plurality of processing devices, denoted 702-1, 702-2, 702-3, . . . 702-K, which communicate with one another over a network 704. The network 704 may comprise any type of network, such as a wireless area network (WAN), a local area network (LAN), a satellite network, a telephone or cable network, a cellular network, a wireless network such as WiFi or WiMAX, or various portions or combinations of these and other types of networks.

The processing device 702-1 in the processing platform 700 comprises a processor 710 coupled to a memory 712. The processor 710 may comprise a microprocessor, a microcontroller, an application specific integrated circuit (ASIC), a field programmable gate array (FPGA) or other type of processing circuitry, as well as portions or combinations of such circuitry elements, and the memory 712, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 6 or 7, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure such as VxRail™, VxRack™, VxBlock™, or Vblock® converged infrastructure commercially available from Dell Technologies.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining, in a storage system, one or more patterns indicating sensitive data, the storage system comprising at least one processing device, the at least one processing device comprising a processor coupled to a memory;
evaluating, in the storage system, whether one or more files of the storage system comprise sensitive data by searching for the one or more patterns in the one or more files; and
classifying, in the storage system, at least one of the one or more files as comprising sensitive data based at least in part on a result of the evaluating.

2. The method of claim 1, further comprising, in response to a file type of a file being written supporting text, storing an identifier of the file being written in a list of files to be evaluated.

3. The method of claim 2, wherein the one or more files subject to the evaluating are identified using the list.

4. The method of claim 1, wherein the evaluating is performed in response to a load of the storage system satisfying one or more sensitive data evaluation criteria.

5. The method of claim 1, wherein the sensitive data comprises personally identifiable information.

6. The method of claim 5, wherein the one or more patterns comprise at least one pattern for each of a plurality of types of personally identifiable information.

7. The method of claim 1, further comprising initiating one or more automated actions in response to at least one of the files being classified as comprising sensitive data.

8. The method of claim 7, wherein the one or more automated actions comprise one or more of: (i) enforcing one or more regulatory requirements for the at least one file, (ii) enforcing one or more industry requirements for the at least one file, (iii) sanitizing the at least one file of the sensitive data, (iv) mitigating a leakage of the sensitive data in the at least one file, and (v) restricting access to the at least one file.

9. An apparatus comprising:
at least one processing device comprising a processor coupled to a memory;
the at least one processing device being configured to implement the following steps:
obtaining, in a storage system, one or more patterns indicating sensitive data;
evaluating, in the storage system, whether one or more files of the storage system comprise sensitive data by searching for the one or more patterns in the one or more files; and
classifying, in the storage system, at least one of the one or more files as comprising sensitive data based at least in part on a result of the evaluating.

10. The apparatus of claim 9, further comprising, in response to a file type of a file being written supporting text, storing an identifier of the file being written in a list of files to be evaluated, and identifying the one or more files subject to the evaluating using the list.

11. The apparatus of claim 9, wherein the evaluating is performed in response to a load of the storage system satisfying one or more sensitive data evaluation criteria.

12. The apparatus of claim 9, wherein the sensitive data comprises personally identifiable information, and wherein the one or more patterns comprise at least one pattern for each of a plurality of types of personally identifiable information.

13. The apparatus of claim 9, further comprising initiating one or more automated actions in response to at least one of the files being classified as comprising sensitive data.

14. The apparatus of claim 13, wherein the one or more automated actions comprise one or more of: (i) enforcing one or more regulatory requirements for the at least one file, (ii) enforcing one or more industry requirements for the at least one file, (iii) sanitizing the at least one file of the sensitive data, (iv) mitigating a leakage of the sensitive data in the at least one file, and (v) restricting access to the at least one file.

15. A non-transitory processor-readable storage medium having stored therein program code of one or more software programs, wherein the program code when executed by at least one processing device causes the at least one processing device to perform the following steps:
obtaining, in a storage system, one or more patterns indicating sensitive data;
evaluating, in the storage system, whether one or more files of the storage system comprise sensitive data by searching for the one or more patterns in the one or more files; and
classifying, in the storage system, at least one of the one or more files as comprising sensitive data based at least in part on a result of the evaluating.

16. The non-transitory processor-readable storage medium of claim 15, further comprising, in response to a file type of a file being written supporting text, storing an identifier of the file being written in a list of files to be evaluated, and identifying the one or more files subject to the evaluating using the list.

17. The non-transitory processor-readable storage medium of claim 15, wherein the evaluating is performed in response to a load of the storage system satisfying one or more sensitive data evaluation criteria.

18. The non-transitory processor-readable storage medium of claim 15, wherein the sensitive data comprises personally identifiable information, and wherein the one or more patterns comprise at least one pattern for each of a plurality of types of personally identifiable information.

19. The non-transitory processor-readable storage medium of claim 15, further comprising initiating one or more automated actions in response to at least one of the files being classified as comprising sensitive data.

20. The non-transitory processor-readable storage medium of claim 20, wherein the one or more automated actions comprise one or more of: (i) enforcing one or more regulatory requirements for the at least one file, (ii) enforcing one or more industry requirements for the at least one file, (iii) sanitizing the at least one file of the sensitive data, (iv) mitigating a leakage of the sensitive data in the at least one file, and (v) restricting access to the at least one file.
